(19) United States
(12) Patent Application Publication
(10) Pub. No.: US 2025/0177933 A1
(43) Pub. Date: Jun. 5, 2025

(54) AGITATOR THAT CIRCULATES MATERIALS

(71) Applicant: WATER CLEAN SYSTEM, Osan-si (KR)

(72) Inventors: Jincheon KIM, Osan-si (KR); Myungkuon SON, Busan (KR); Jeajin RYU, Osan-si (KR); Sungsoo LEE, Busan (KR)

(73) Assignee: WATER CLEAN SYSTEM, Osan-si (KR)

(21) Appl. No.: 18/526,990

(22) Filed: Dec. 1, 2023

(30) Foreign Application Priority Data
Oct. 4, 2022 (KR) 10-2022-0126272

(51) Int. Cl. B01F 25/51; B01F 25/23; B01F 25/433; B01F 25/434; B01F 33/451

(52) U.S. Cl. CPC B01F 25/51; B01F 25/23; B01F 25/4332; B01F 25/434; B01F 33/451

(57) ABSTRACT

Disclosed is an agitator that circulates materials including an agitation tank into which an agitation target is inputted, a base plate configured to support the agitation tank from below the agitation tank, pumps fixedly installed on the base plate, connected to a lower end of the agitation tank through suction pipes, and configured to suck the agitation target in the agitation tank, the pumps being connected to an upper end of the agitation tank through discharge pipes and configured to circulate the sucked agitation target by discharging the agitation target to the upper end of the agitation tank, and an agitation activator installed in at least one of the suction pipe and the discharge pipe and configured to promote agitation of the agitation target.

### CROSS-REFERENCE TO RELATED APPLICATIONS

This application claims the priority of Korean Patent Application No. 10-2022-0126272 filed on Oct. 4, 2022, in the Korean Intellectual Property Office, the disclosure of which is incorporated herein by reference.

### BACKGROUND

### Field

The present disclosure relates to an agitator used to agitate a liquid material, and more particularly, to an agitator that circulates materials that performs agitation by circulating an agitation target while sucking the agitation target stored in an agitation tank and then discharging the agitation target to the agitation tank, thereby micronizing and activating molecules of the agitation target and improving agitation efficiency.

### Description of the Related Art

In general, an agitator refers to a device used to mix or stir solids, liquids, gases, and the like. An agitator, in which an agitation blade is disposed in an agitation tank and the agitation blade performs agitation by mixing objects in the agitation tank while being rotated by a motor, is most widely used.

In the case of the above-mentioned agitator, an agitation target stored in the agitation tank is agitated as particles, which constitute the agitation target, collide with one another while the particles are rotated in the agitation tank by the rotation of the agitation blade.

Meanwhile, a predetermined swirl is formed in the agitation tank by the rotation of the agitation blade, and a relatively strong swirl is formed at the periphery of the agitation blade, which degrades an agitation effect in the vicinity of an inner wall of the agitation tank.

Meanwhile, a multi-stage agitator, in which agitation blades are provided at multiple stages, is used to perform entirely uniform agitation in the agitation tank. However, the multi-stage agitator has a complicated structure, which causes a problem in that the maintenance cannot be easily performed, a large amount of costs is required to manufacture the multi-stage agitator, and a large amount of energy is required to operate the multi-stage agitator.

In addition, because a high load is consistently applied to the agitation blade that is forcibly rotated in the agitation target by the operation of the motor, there is a problem in that there is a high likelihood that the agitation blade is deformed and the motor is burnt out, and an accident is highly likely to occur during a process of cleaning the agitation blade.

### DOCUMENT OF RELATED ART

### Patent Document

(Patent Document 1) Korean Patent No. 10-1179201 (published on Sep. 3, 2012)

### SUMMARY

An object to be achieved by the present disclosure is to provide an agitator that circulates materials including an agitation activator that performs agitation by circulating an agitation target by using a pump without using an agitation blade, thereby micronizing and activating molecules of the agitation target and improving agitation efficiency.

Another object to be achieved by the present disclosure is to provide an agitator that circulates materials, the position of which may be adjusted.

Still another object to be achieved by the present disclosure is to provide an agitator that circulates materials in which two flows of an agitation target circulated by a pump collide with each other, thereby implementing more effective agitation.

According to an aspect of the present disclosure, an agitator that circulates materials includes: an agitation tank into which an agitation target is inputted; a base plate configured to support the agitation tank from below the agitation tank; pumps fixedly installed on the base plate, connected to a lower end of the agitation tank through suction pipes, and configured to suck the agitation target in the agitation tank, the pumps being connected to an upper end of the agitation tank through discharge pipes and configured to circulate the sucked agitation target by discharging the agitation target to the upper end of the agitation tank; and an agitation activator installed in at least one of the suction pipe and the discharge pipe and configured to promote agitation of the agitation target.

Meanwhile, in the agitator that circulates materials, the pumps may include a first pump and a second pump, the first pump may be connected to the agitation tank through a first suction pipe and a first discharge pipe, and the second pump may be connected to the agitation tank through a second suction pipe and a second discharge pipe, such that the first and second pumps independently circulate the agitation target, and the first discharge pipe and the second discharge pipe may be formed such that two flows formed by the agitation target discharged into the agitation tank collide with each other while intersecting each other in the agitation tank.

Meanwhile, the agitator that circulates materials may further include: a plurality of stoppers provided uprightly in a vertical posture from an upper surface of the base plate and installed on the base plate to support the lower end of the agitation tank in forward, rearward, leftward, and rightward directions; and a plurality of casters distributed and installed on a bottom surface of the base plate to make it easy to move a position of the agitator that circulates materials.

Meanwhile, in the agitator that circulates materials, the agitation activator may include: a tubular housing having an inlet port formed at one side thereof, and a discharge port formed at a side opposite to the inlet port; a copper pipe made of copper and installed and structured to be in close contact with an inner peripheral surface of the tubular housing; a first treatment member disposed in the copper pipe so as to come into earliest contact with the agitation target introduced into the tubular housing, the first treatment member being made of copper, having a two-stage structure including a large-diameter portion provided to be in close contact with the inner peripheral surface of the copper pipe, and a small-diameter portion spaced apart from the inner peripheral surface of the copper pipe, and configured such that the agitation target is introduced through a central portion of the large-diameter portion and then discharged into a space between the small-diameter portion and the copper pipe while being distributed in a circumferential direction of the small-diameter portion; a second treatment member made of zinc and having a two-stage structure including a large-diameter portion provided to be in close contact with the inner peripheral surface of the copper pipe, and a small-diameter portion spaced apart from the inner peripheral surface of the copper pipe, the second treatment member being disposed in the copper pipe so that the small-diameter portion faces the small-diameter portion of the first treatment member and configured such that the agitation target is introduced inward through the small-diameter portion and then discharged through a central portion of the large-diameter portion; magnets installed outside the copper pipe to form a magnetic field between the first treatment member and the second treatment member; a third treatment member made of polytetrafluoroethylene and having a two-stage structure including a large-diameter portion provided to be in close contact with the inner peripheral surface of the copper pipe, and a small-diameter portion spaced apart from the inner peripheral surface of the copper pipe, the third treatment member being disposed in the copper pipe so that the large-diameter portion faces the large-diameter portion of the second treatment member and configured such that the agitation target introduced inward through a central portion of the large-diameter portion and then discharged into a space between the small-diameter portion and the copper pipe while being distributed in a circumferential direction of the small-diameter portion; and a fourth treatment member made of copper and having a two-stage structure including a large-diameter portion provided to be in close contact with the inner peripheral surface of the copper pipe, and a small-diameter portion spaced apart from the inner peripheral surface of the copper pipe, the fourth treatment member being disposed in the copper pipe so that the small-diameter portion faces the small-diameter portion of the third treatment member and configured such that the agitation target is introduced through the small-diameter portion and then discharged through a central portion of the large-diameter portion.

Meanwhile, the agitator that circulates materials may further include: a plurality of first space forming protrusions protruding from an end surface of the small-diameter portion of the first treatment member toward the second treatment member and spaced apart from one another in the circumferential direction of the small-diameter portion to define inlets through which the agitation target is introduced; and a plurality of second space forming protrusions protruding from an end surface of the small-diameter portion of the second treatment member toward the first treatment member and spaced apart from one another in the circumferential direction of the small-diameter portion to define inlets through which the agitation target is introduced, the second space forming protrusions being in close contact with the first space forming protrusions while facing the first space forming protrusions so that the first treatment member and the second treatment member are spaced apart from each other to define an activation space.

Meanwhile, in the agitator that circulates materials, the magnets may be installed on the copper pipe, positioned in a section between the first treatment member and the second treatment member, and configured to form a magnetic field in the activation space.

Meanwhile, the second treatment member may include: a plurality of first inflow holes formed and distributed in the end surface of the small-diameter portion so that the agitation target in the activation space is introduced into the large-diameter portion; and a plurality of second inflow holes distributed in the circumferential direction between the small-diameter portion and the large-diameter portion, disposed in an obliquely inclined posture, and connected to an internal space of the large-diameter portion.

Meanwhile, in the agitator that circulates materials, two opposite surfaces of the first space forming protrusion and two opposite surfaces of the second space forming protrusion, which define the inlet, may be formed to be inclined so that the agitation target introduced into the activation space through the inlet creates a flow swirling in the activation space.

According to the present disclosure characterized as described above, the agitation activator installed in the suction pipe or the discharge pipe may micronize molecules of the agitation target and increase activity of the molecules of the agitation target by using vortices, magnetic fields, static electricity, and galvanic electricity, thereby further improving agitation efficiency.

In addition, the agitator may be configured to agitate the agitation target by circulating the agitation target without using an agitation blade, thereby simplifying the structure, reducing the costs required to manufacture the agitator, and reducing energy required to operate the agitator.

In addition, the position of the agitator may be moved by using the casters, thereby improving convenience of use.

In addition, the flows of the agitation target formed in the agitation tank may collide with one another, thereby improving agitation efficiency.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a front view of an agitator that circulates materials according to an exemplary embodiment of the present disclosure;

FIG. 2 is a top plan view illustrating a state in which first and second pumps according to the exemplary embodiment of the present disclosure are connected to an agitation tank through first and second suction pipes;

FIG. 3 is an exemplified view illustrating a state in which two flows collide with each other in the agitation tank according to the present disclosure;

FIG. 4 is a partially cut-out perspective view illustrating an agitation activator according to the exemplary embodiment of the present disclosure;

FIG. 5 is a cross-sectional view illustrating an internal structure of the agitation activator according to the exemplary embodiment of the present disclosure;

FIG. 6 is an exploded perspective view of the agitation activator according to the exemplary embodiment of the present disclosure;

FIG. 7 is a cross-sectional view illustrating an internal structure of a tubular housing according to the exemplary embodiment of the present disclosure;

FIG. 8 is a perspective view of a first treatment member according to the exemplary embodiment of the present disclosure;

FIG. 9 is a perspective view of a second treatment member according to the exemplary embodiment of the present disclosure;

FIG. 10 is a perspective view of a third treatment member according to the exemplary embodiment of the present disclosure;

FIG. 11 is a perspective view of a fourth treatment member according to the exemplary embodiment of the present disclosure;

FIG. 12 is a front view of the second treatment member having a structure in which lateral surfaces of second space forming protrusions according to the present disclosure are inclined; and

FIG. 13 is an exemplified view illustrating a state in which ions and electrons move while colliding with flows of an agitation target in an activation space according to the present disclosure.

### DETAILED DESCRIPTION OF THE EMBODIMENT

Hereinafter, exemplary embodiments of the present disclosure will be described in detail with reference to the accompanying drawings. In the description of the present disclosure, the specific descriptions of related well-known functions or configurations will be omitted when it is determined that the specific descriptions may unnecessarily obscure the subject matter of the present disclosure.

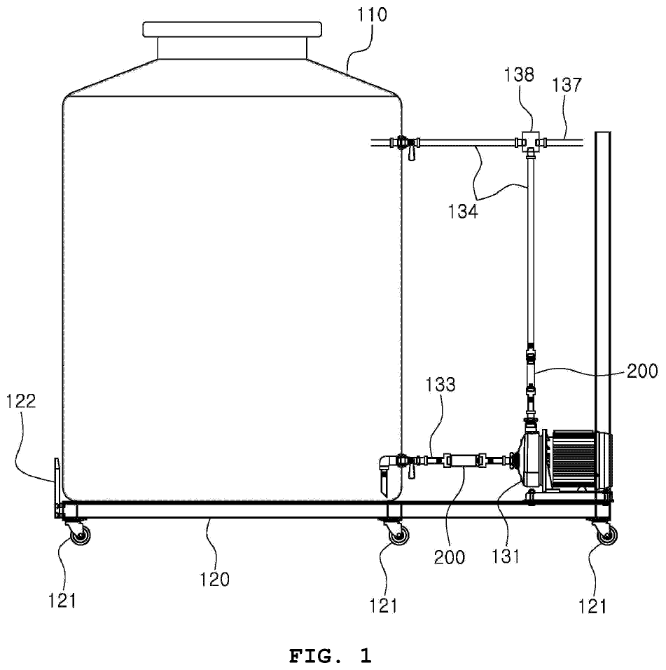

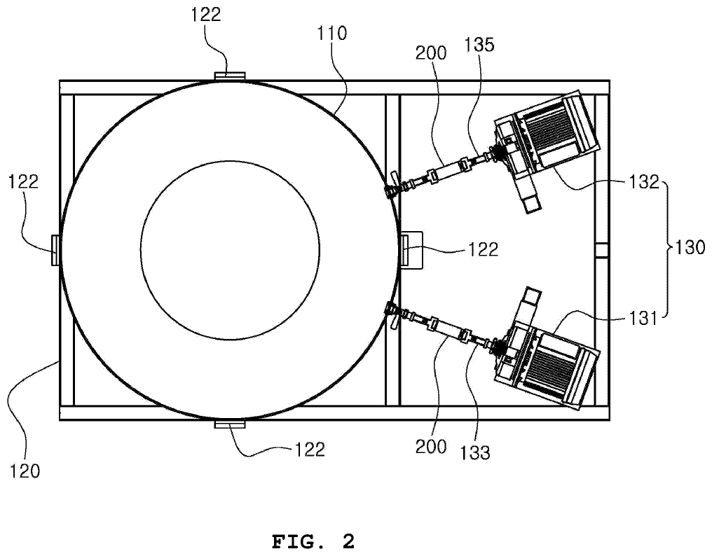

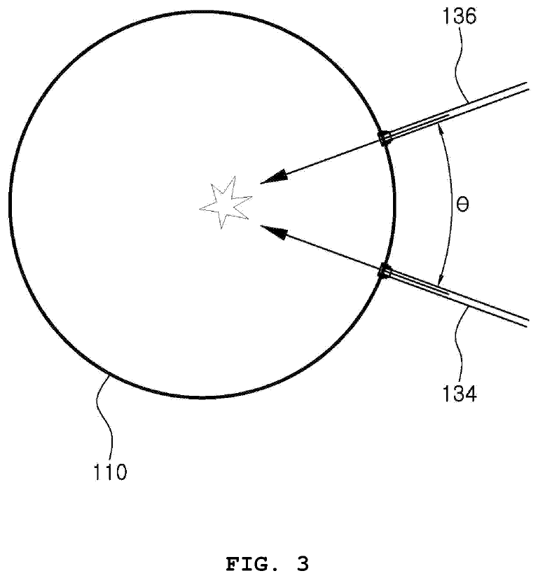

FIG. 1 is a front view of an agitator that circulates materials according to an exemplary embodiment of the present disclosure, FIG. 2 is a top plan view illustrating a state in which first and second pumps according to the exemplary embodiment of the present disclosure are connected to an agitation tank through first and second suction pipes, and FIG. 3 is an exemplified view illustrating a state in which two flows collide with each other in the agitation tank according to the present disclosure.

An agitator that circulates materials according to the present disclosure includes an agitation tank 110, a base plate 120, pumps 130, and an agitation activator 200.

An upper end of the agitation tank 110 is opened so that an agitation target may be inputted into the agitation tank 110 through the upper end. The agitation tank 110 is configured to store a predetermined amount of agitation target.

The base plate 120 serves to support the agitation tank 110 from below the agitation tank 110. The base plate 120 may be configured by installing board horizontally on upper and lower portions of a quadrangular frame made by coupling a plurality of quadrangular pipes in a quadrangular shape.

Meanwhile, a plurality of casters 121 is distributed and installed on a bottom surface of the base plate 120 so that the base plate 120 may move. Stoppers 122 are distributed and installed on an upper surface of the base plate 120 and configured to support a lower end of the agitation tank 110 on lateral surfaces of the base plate 120 and fix the agitation tank 110 to an exact position.

The stopper 122 is provided in the form of a board installed uprightly in a vertical posture from the upper surface of the base plate 120. The four stoppers 122 are installed on the upper surface of the base plate 120 to support the agitation tank 110 in forward, rearward, leftward, and rightward directions of the agitation tank 110.

Therefore, during the process of installing the agitation tank 110 on the upper portion of the base plate 120, the agitation tank 110 may be installed on the base plate 120 without a separate fixing process as the agitation tank 110 is only positioned so that the lower end of the agitation tank 110 is positioned between the four stoppers 122.

The pump 130 is fixedly installed on the upper surface of the base plate 120, connected to the lower end of the agitation tank 110 through a suction pipe, and configured to suck the agitation target stored in the agitation tank 110. The pump 130 is connected to the upper end of the agitation tank 110 through a discharge pipe and configured to discharge the sucked agitation target to the upper end of the agitation tank 110.

Meanwhile, the pumps 130 according to the exemplary embodiment of the present disclosure include a first pump 131 and a second pump 132. The first pump 131 is connected to the agitation tank 110 through a first suction pipe 133 and a first discharge pipe 134, and the second pump 132 is connected to the agitation tank 110 through a second suction pipe 135 and a second discharge pipe 136, such that the first pump 131 and the second pump 132 independently circulate the agitation target.

Meanwhile, both the first discharge pipe 134 and the second discharge pipe 136 are installed to be connected to the upper end of the agitation tank 110. The first discharge pipe 134 and the second discharge pipe 136 may be installed to have an included angle θ, which is an acute angle, so that a flow, which is formed by the agitation target discharged into the agitation tank 110 through the first discharge pipe 134, collides with a flow formed by the agitation target discharged into the agitation tank 110 through the second discharge pipe 136.

In addition, a drain pipe 137 may be installed to be connected to the first and second discharge pipes 134 and 136 by means of a three-way valve 138 in order to discharge the contents in the agitation tank 110 to the outside by using the first and second pumps 131 and 132.

According to the agitator that circulates materials configured as described above, the agitation target in the agitation tank 110 is circulated repeatedly through the first suction pipe 133, the first pump 131, the first discharge pipe 134, the second suction pipe 135, the second pump 132, and the second discharge pipe 136 by the operation of the first pump 131 and the operation of the second pump 132. During this process, the agitation targets are naturally mixed.

The agitation activator 200 serves to promote the mixing between the agitation targets and is installed in at least one of the suction pipe and the discharge pipe. Particularly, the agitation activators 200 are respectively installed in the first and second suction pipes 133 and 135 and the first and second discharge pipes 134 and 136.

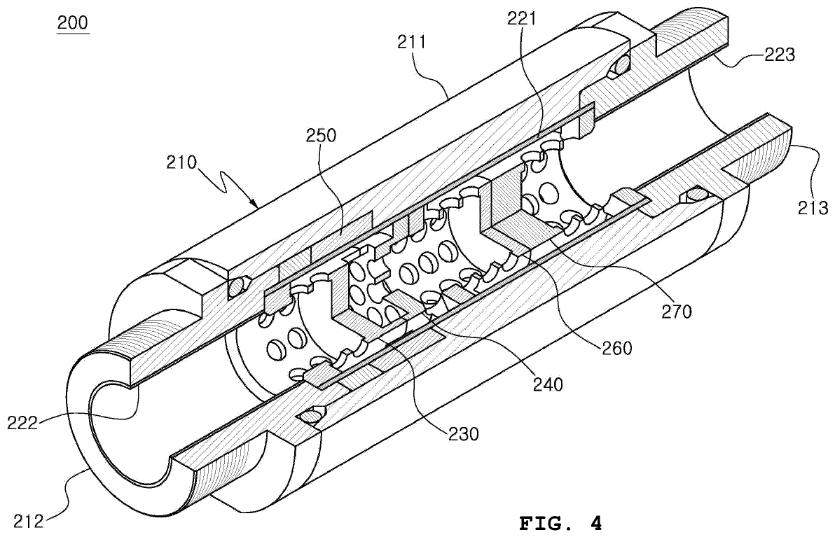

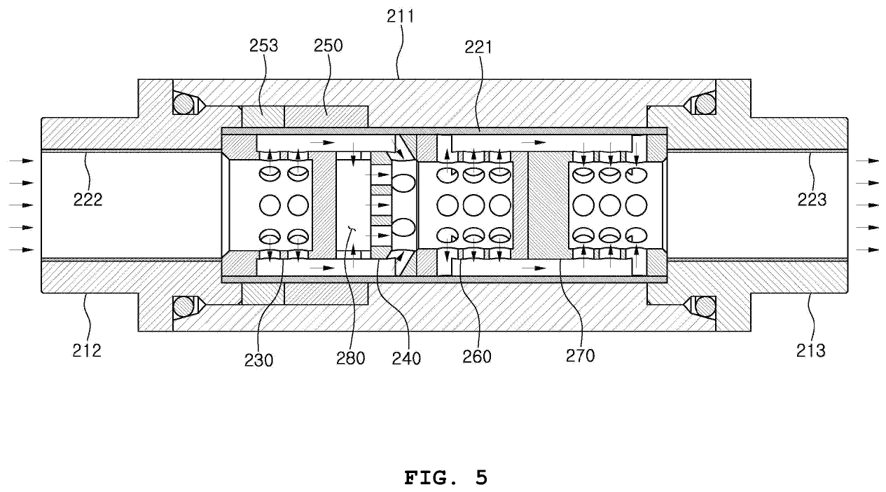

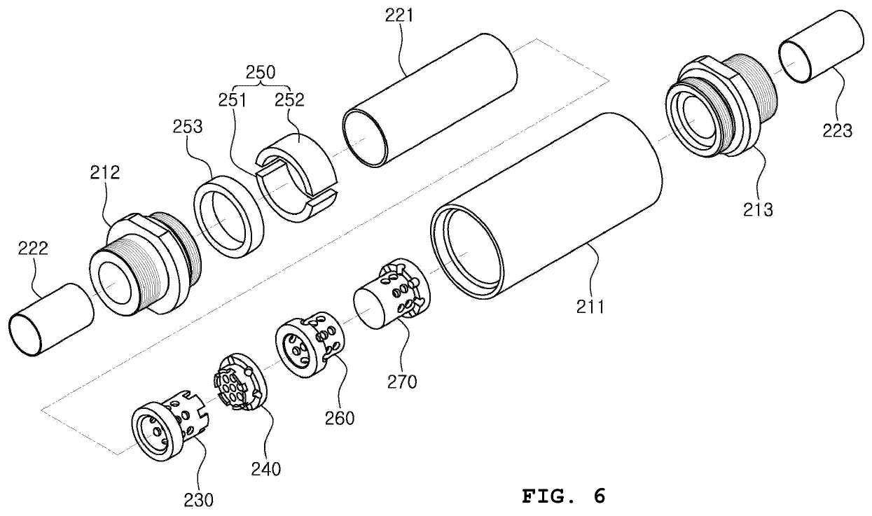

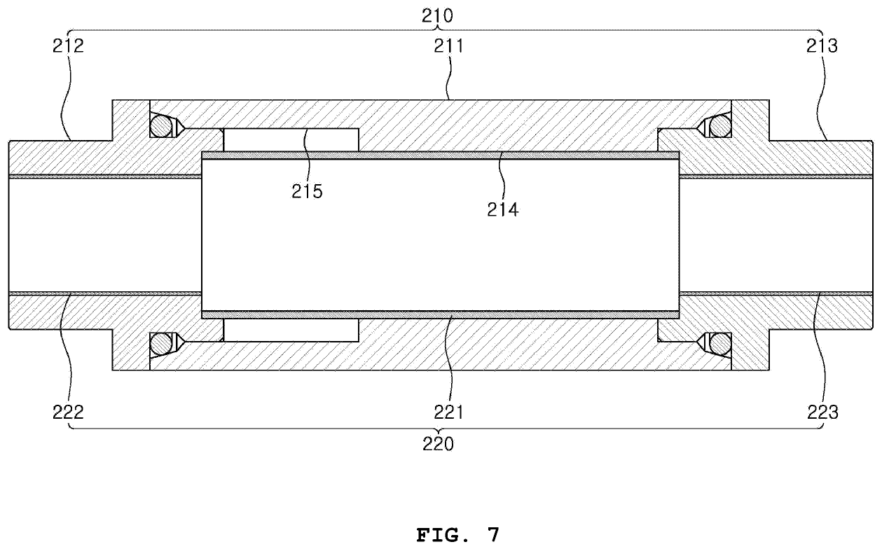

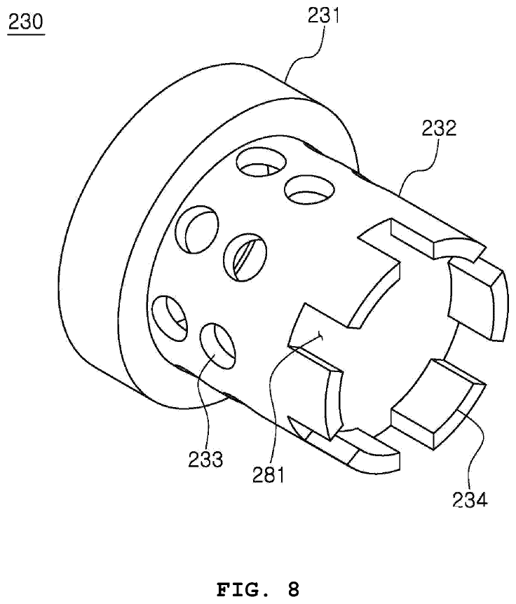

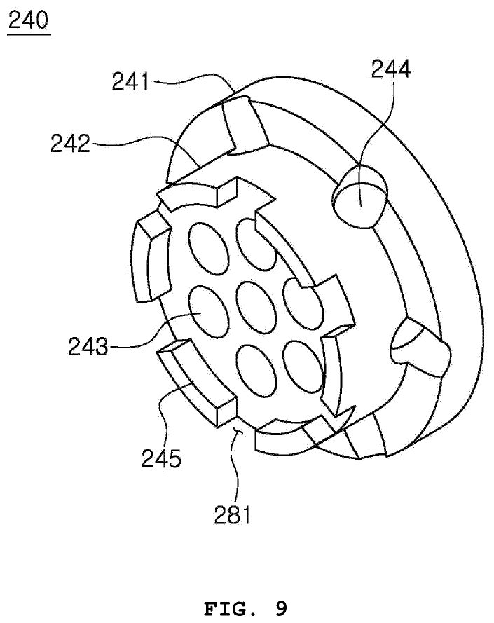

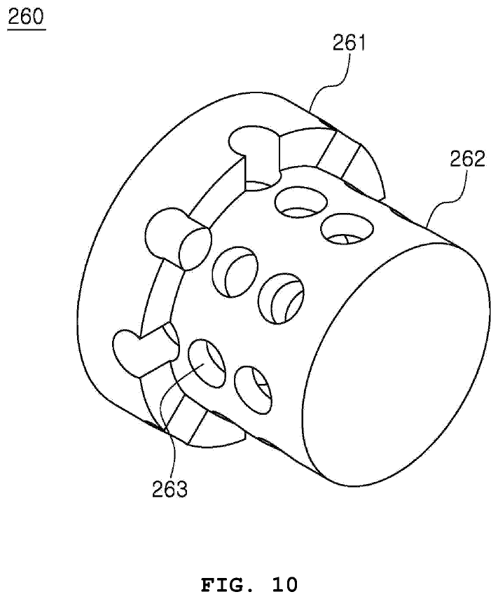

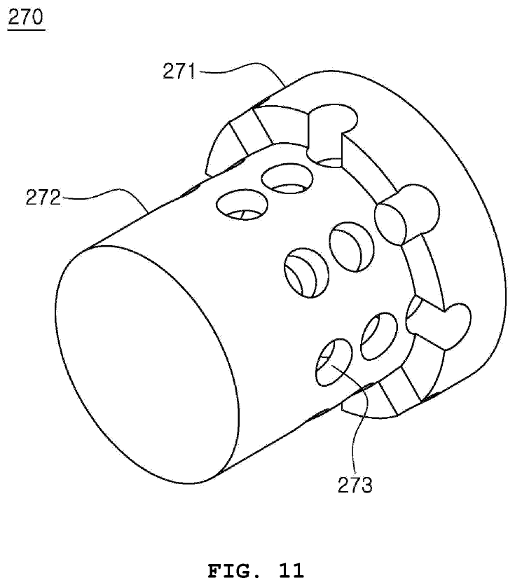

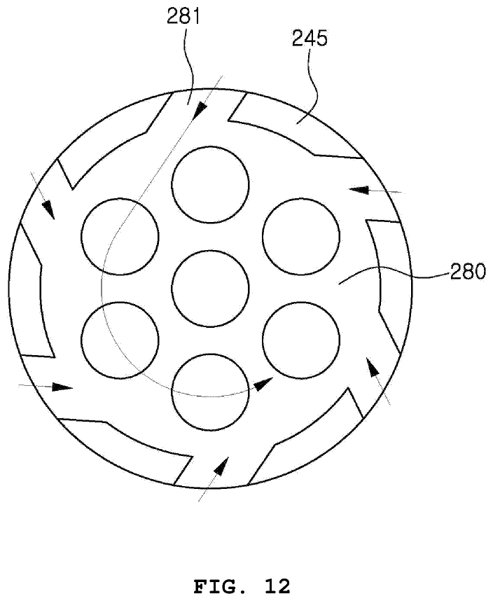

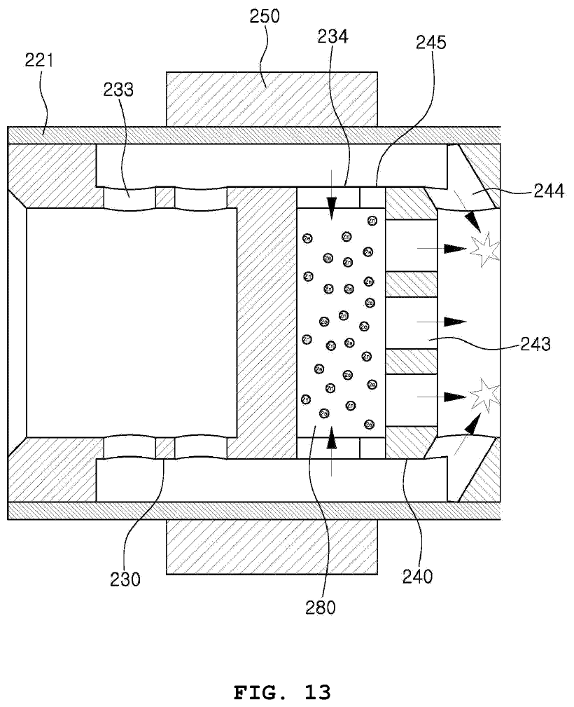

FIG. 4 is a partially cut-out perspective view illustrating an agitation activator according to the exemplary embodiment of the present disclosure, FIG. 5 is a cross-sectional view illustrating an internal structure of the agitation activator according to the exemplary embodiment of the present disclosure, FIG. 6 is an exploded perspective view of the agitation activator according to the exemplary embodiment of the present disclosure, FIG. 7 is a cross-sectional view illustrating an internal structure of a tubular housing according to the exemplary embodiment of the present disclosure, FIG. 8 is a perspective view of a first treatment member according to the exemplary embodiment of the present disclosure, FIG. 9 is a perspective view of a second treatment member according to the exemplary embodiment of the present disclosure, FIG. 10 is a perspective view of a third treatment member according to the exemplary embodiment of the present disclosure, FIG. 11 is a perspective view of a fourth treatment member according to the exemplary embodiment of the present disclosure, FIG. 12 is a front view of the second treatment member having a structure in which lateral surfaces of second space forming protrusions according to the present disclosure are inclined, and FIG. 13 is an exemplified view illustrating a state in which ions and electrons move while colliding with flows of an agitation target in an activation space according to the present disclosure.

The agitation activator 200 serves to improve agitation efficiency by micronizing molecules of the agitation target and increasing the activity of the molecules of the agitation target by using vortices, magnetic fields, static electricity, and galvanic electricity. The agitation activator 200 includes a tubular housing 210, a copper pipe 220, a first treatment member 230, a second treatment member 240, magnets 250, a third treatment member 260, a fourth treatment member 270. The agitation activator 200 is configured such that the agitation target introduced into one side of the tubular housing 210 sequentially passes through the first, second, third, and fourth treatment members 230, 240, 260, and 270 and then is discharged to the other side of the tubular housing 210.

The tubular housing 210 is configured by screw-coupling a first flange part 212 having an inlet port to one side of a body part 211 having a cylindrical structure and by screw-coupling a second flange part 213 having a discharge port to the other side of the body part 211.

Meanwhile, a first inner-diameter portion 214 is formed in the body part 211 so that a first copper pipe 221 to be described below is installed to be in close contact with the first inner-diameter portion 214. A second inner-diameter portion 215 is formed in the body part 211 so that the magnets 250 are installed to be in close contact with the second inner-diameter portion 215. The second inner-diameter portion 215 is formed to have a larger inner diameter than the first inner-diameter portion 214.

The first and second flange parts 212 and 213 are assembled to the body part 211 by screw-coupled in a state in which the first and second flange parts 212 and 213 are partially inserted into the body part 211. An inner diameter of each of the first and second flange parts 212 and 213 is smaller than an inner diameter of the body part 211, and external thread portions are formed at outer ends of the first and second flange parts 212 and 213 so as to be coupled to the pipe.

The copper pipe 220 is installed inside the tubular housing 210 so as to come into contact with the agitation target passing through the tubular housing 210.

More specifically, the copper pipe 220 according to the exemplary embodiment of the present disclosure includes the first copper pipe 221 installed such that an outer peripheral surface thereof is in close contact with an inner peripheral surface of the body part 211, a second copper pipe 222 installed such that an outer peripheral surface thereof is in close contact with an inner peripheral surface of the first flange part 212, and a third copper pipe 223 installed such that an outer peripheral surface thereof is in close contact with an inner peripheral surface of the second flange part 213. All the first, second, and third copper pipes 221, 222, and 223 are made of copper (Cu).

Meanwhile, the first copper pipe 221 is assembled to the body part 211 while penetrating the first inner-diameter portion 214, one end of the first copper pipe 221 is inserted into the first flange part 212 and coupled to the first flange part 212, and the other end of the first copper pipe 221 is inserted into the second flange part 213 and coupled to the second flange part 213.

The first treatment member 230 is provided in the first copper pipe 221 and installed on an inner tip portion of the first copper pipe 221 so as to come into earliest contact with the agitation target introduced into the tubular housing 210. The first treatment member 230 is made of copper (Cu) and has a two-stage structure including a large-diameter portion 231 and a small-diameter portion 232.

An outer peripheral surface of the large-diameter portion 231 of the first treatment member 230 is formed to be in close contact with the inner peripheral surface of the first copper pipe 221, an outer peripheral surface of the small-diameter portion 232 of the first treatment member 230 is formed to be spaced apart from the inner peripheral surface of the first copper pipe 221, and a plurality of first discharge holes 233 is formed around a circumference of the small-diameter portion 232 and distributed in circumferential and length directions.

In addition, among the two opposite ends of the first treatment member 230, the end adjacent to the large-diameter portion 231 is opened, and the end adjacent to the small-diameter portion 232 is closed. The first treatment member 230 is installed in the first copper pipe 221 so that the agitation target introduced into the tubular housing 210 is introduced into the first treatment member 230 through the large-diameter portion 231 and then discharged to a space defined between the first copper pipe 221 and the small-diameter portion 232 while being distributed in the circumferential direction of the small-diameter portion 232 through the plurality of first discharge holes 233.

The second treatment member 240 is installed inside the first copper pipe 221 and positioned rearward of the first treatment member 230 based on the direction in which the agitation target flows. The second treatment member 240 is made of zinc (Zn) and has a two-stage structure including a large-diameter portion 241 and a small-diameter portion 242.

An outer peripheral surface of the large-diameter portion 241 of the second treatment member 240 is formed to be in close contact with the inner peripheral surface of the first copper pipe 221, and an outer peripheral surface of the small-diameter portion 242 of the second treatment member 240 is formed to be spaced apart from the inner peripheral surface of the first copper pipe 221. In addition, among the two opposite ends of the second

treatment member 240, the end adjacent to the large-diameter portion 241 is opened, and the end adjacent to the small-diameter portion 242 is closed. The second treatment member 240 is installed in the first copper pipe 221 so that the small-diameter portion 242 faces the small-diameter portion 232 of the first treatment member 230 so that the agitation target is introduced into the second treatment member 240 through the small-diameter portion 242 and then discharged through the large-diameter portion 241.

In addition, a plurality of first inflow holes 243 is formed and distributed in an end surface of the small-diameter portion 242 of the second treatment member 240 so that the agitation target is introduced into the second treatment member 240 through the small-diameter portion 242. A plurality of second inflow holes 244 is formed in a boundary region between the large-diameter portion 241 and the small-diameter portion 242 of the second treatment member 240 and distributed in the circumferential direction so that the agitation target in the copper pipe 220 may be introduced into the second treatment member 240.

In this case, the second inflow holes 244 extend in obliquely inclined postures and are connected to an interior of the large-diameter portion 241 so that the agitation target introduced into the large-diameter portion 241 through the second inflow holes 244 is guided to collide with a flow of the agitation target introduced into the large-diameter portion 241 through the first inflow holes 243.

Meanwhile, an activation space 280 may be further formed between the first treatment member 230 and the second treatment member 240 to induce activation of ions and electrons by amplifying energy of the ions and electrons contained in the agitation target.

In order to define the activation space 280, a plurality of first space forming protrusions 234 is formed in an end surface of the small-diameter portion 232 of the first treatment member 230, and a plurality of second space forming protrusions 245 is formed in an end surface of the small-diameter portion 242 of the second treatment member 240. The first space forming protrusions 234 and the second space forming protrusions 245 are in close contact with one another while facing one another, such that the activation space 280 is defined between the first treatment member 230 and the second treatment member 240.

More specifically, the plurality of first space forming protrusions 234 protrudes from the end surface of the small-diameter portion 232 of the first treatment member 230 toward the second treatment member 240, and the plurality of first space forming protrusions 234 is formed to be spaced apart from one another in the circumferential direction of the small-diameter portion 232, thereby defining inlets 281 through which the agitation target in the first copper pipe 221 is introduced into the activation space 280.

The plurality of second space forming protrusions 245 protrudes from the end surface of the small-diameter portion 242 of the second treatment member 240 toward the first treatment member 230, and the plurality of second space forming protrusions 245 is formed to be spaced apart from one another in the circumferential direction of the small-diameter portion 242, thereby defining the inlets 281 through which the agitation target in the first copper pipe 221 is introduced into the activation space 280.

Meanwhile, the first space forming protrusions 234 and the second space forming protrusions 245 may be identical in number and structure to one another. A width of each of the space forming protrusions may be larger than a width of each of the spaces defined between the space forming protrusions, i.e., a width of the inlet 281 so that the space forming protrusions 234 and 245 cannot be inserted into the inlets 281.

In addition, the inlet 281 defined by the first space forming protrusions 234 and the inlet 281 defined by the second space forming protrusions 245 may be connected to each other to define a single inlet or separated from each other to define the independent inlets.

In addition, two opposite surfaces of the first space forming protrusion 234 and two opposite surfaces of the second space forming protrusion 245, which define the inlets 281, may be formed to be inclined so that the agitation target introduced into the activation space 280 through the inlet 281 creates a flow swirling in the circumferential direction in the activation space 280.

For example, FIG. 12 illustrates a structure in which the two opposite surfaces of the second space forming protrusion 245 are inclined and the lateral surfaces of the two second space forming protrusions 245, which face each other to define the inlet 281, are inclined in the same direction so that the agitation target introduced through the inlets 281 defined between the second space forming protrusions 245 creates a flow swirling counterclockwise in the activation space 280. Although not illustrated, the lateral surface of the first space forming protrusion 234 may also be inclined in the same way as the lateral surface of the second space forming protrusion 245.

In addition, a sum of an overall opening area of the inlets 281 defined by the first space forming protrusions 234 and the first space forming protrusions 234 and an overall opening area of the second inflow holes 244 may be equal to or larger than an overall opening area of first discharge holes 233 formed in the small-diameter portion 232 of the first treatment member 230, such that the agitation target does not stagnate between the first treatment member 230 and the second treatment member 240.

The magnets 250 serve to form a magnetic field in the activation space 280 defined between the first treatment member 230 and the second treatment member 240 and includes two permanent magnets 250 each having a semi-circular shape and installed with the first copper pipe 221 interposed therebetween.

Meanwhile, the permanent magnets 250 are disposed on the second inner-diameter portion 215 of the body part 211 of the tubular housing 210, and a ring-shaped spacer 253 is further installed on the second inner-diameter portion 215 to suppress inadvertent movements of the permanent magnets 250.

The third treatment member 260 is installed inside the first copper pipe 221 and positioned rearward of the second treatment member 240 based on the direction in which the agitation target flows. The third treatment member 260 is made of polytetrafluoroethylene and has a two-stage structure including a large-diameter portion 261 and a small-diameter portion 262.

An outer peripheral surface of the large-diameter portion 261 of the third treatment member 260 is formed to be in close contact with the inner peripheral surface of the first copper pipe 221, an outer peripheral surface of the small-diameter portion 262 of the third treatment member 260 is formed to be spaced apart from the inner peripheral surface of the first copper pipe 221, and a plurality of second discharge holes 263 is formed around a circumference of the small-diameter portion 262 and distributed in circumferential and length directions.

In addition, among the two opposite ends of the third treatment member 260, the end adjacent to the large-diameter portion 261 is opened, and the end adjacent to the small-diameter portion 262 is closed. The third treatment member 260 is installed in the first copper pipe 221 so that the large-diameter portion 261 faces the large-diameter portion 241 of the second treatment member 240 so that the agitation target is introduced into the third treatment member 260 through the large-diameter portion 261 and then discharged to a space defined between the first copper pipe 221 and the small-diameter portion 262 while being distributed in the circumferential direction of the small-diameter portion 262 through the plurality of second discharge holes 263.

The fourth treatment member 270 is installed inside the first copper pipe 221 and positioned rearward of the third treatment member 260 based on the direction in which the agitation target flows. The fourth treatment member 270 is made of copper (Cu) and has a two-stage structure including a large-diameter portion 271 and a small-diameter portion 272.

An outer peripheral surface of the large-diameter portion 271 of the fourth treatment member 270 is formed to be in close contact with the inner peripheral surface of the first copper pipe 221, an outer peripheral surface of the small-diameter portion 272 of the fourth treatment member 270 is formed to be spaced apart from the inner peripheral surface of the first copper pipe 221, and a plurality of third inflow holes 273 is formed around a circumference of the small-diameter portion 272 and distributed in the circumferential and length directions.

In addition, among the two opposite ends of the fourth treatment member 270, the end adjacent to the large-diameter portion 271 is opened, and the end adjacent to the small-diameter portion 272 is closed. The fourth treatment member 270 is installed in the first copper pipe 221 so that the small-diameter portion 272 faces the small-diameter portion 272 of the third treatment member 260 so that the agitation target is introduced into the fourth treatment member 270 through the third inflow holes 273 formed in the small-diameter portion 272 and then discharged into the third copper pipe 223 through the large-diameter portion 271.

In case that the agitation activators 200, which are configured as described above, are respectively installed in the suction pipes and the discharge pipes, the agitation target flowing through the corresponding pipe is introduced into the agitation activator 200 through an inlet port defined by the first flange part 212 and comes into earliest contact with the second copper pipe 222 installed in the first flange part 212. The agitation target is primarily sterilized by contact with the second copper pipe 222 made of copper.

The agitation target introduced into the first copper pipe 221 after passing through the second copper pipe 222 is introduced into the first treatment member 230 through the large-diameter portion 231 of the first treatment member 230 and discharged into the space between the small-diameter portion 232 and the first copper pipe 221 through the plurality of first discharge holes 233 formed in the small-diameter portion 232 of the first treatment member 230.

A part of the agitation target discharged into the first copper pipe 221 from the small-diameter portion 232 of the first treatment member 230 is introduced into the activation space 280 through the inlets 281 connected to the activation space 280 defined between the first treatment member 230 and the second treatment member 240. The remaining part of the agitation target is introduced into the large-diameter portion 241 of the second treatment member 240 through the second inflow holes 244.

Meanwhile, the first treatment member 230 is made of copper, the second treatment member 240 is made of zinc, and the first treatment member 230 and the second treatment member 240 are electrically connected to each other through the first copper pipe 221, such that electrical energy is generated by a potential difference between copper and zinc between the first treatment member 230 and the second treatment member 240. Therefore, the electrical energy, i.e., galvanic electricity generated between the first treatment member 230 and the second treatment member 240 may promote micronization and activation of molecules that constitute the agitation target.

Meanwhile, vortices are generated during a process in which the agitation target is discharged from the small-diameter portion 232 of the first treatment member 230 and collides with the inner wall of the first copper pipe 221 and a process in which the agitation target in the first copper pipe 221 is introduced into the activation space 280 through the inlet 281. The vortices may induce active collisions between the molecules of the agitation target, thereby further promoting atomization of the molecules of the agitation target.

Further, the atomization of the molecules of the agitation target is further accelerated by magnetic fields formed in the activation space 280 and formed around the activation space 280 by the magnets 250 installed to be positioned in the boundary region between the first treatment member 230 and the second treatment member 240.

In particular, in the agitation activator 200, the ions and electrons discharged from the second treatment member 240 into the activation space 280 collide with the agitation target introduced into the activation space 280 through the inlets 281 and flow irregularly, which amplifies energy and increases activity. Therefore, the galvanic electricity, which is generated between the first and second treatment members 230 and 240, and the magnetic field, which is formed in the activation space 280 by the magnets 250, increase the activity of the ions and electrons contained in the agitation target and improve the agitation efficiency.

Meanwhile, the agitation target introduced into the activation space 280 is introduced into the large-diameter portion 241 of the second treatment member 240 through the first inflow holes 243 formed in the second treatment member 240. In this process, the flow of the agitation target introduced into the large-diameter portion 241 through the first inflow holes 243 and the flow of the agitation target introduced into the large-diameter portion 241 through the second inflow holes 244 generate vortices while colliding with each other. In this process, the agitation efficiency is improved.

The agitation target having passed through the second treatment member 240 is introduced through the large-diameter portion 261 of the third treatment member 260 made of polytetrafluoroethylene and then discharged into the first copper pipe 221 through the small-diameter portion 262. During this flowing process of the agitation target, static electricity is generated by friction between the agitation target and the polytetrafluoroethylene, and the generated static electricity and the vortices, which are generated during the process in which the agitation target passes through the third treatment member 260, promote the agitation of the agitation target.

The agitation target, which passes through the third treatment member 260 and is discharged into the first copper pipe 221, is introduced through the small-diameter portion 272 of the fourth treatment member 270 made of copper and then discharged into the third copper pipe 223 through the large-diameter portion 271. The static electricity and vortices, which are generated during the flowing process of the agitation target, more effectively agitate the agitation target.

As described above, the agitator that circulates materials according to the present disclosure has the structure that may be easily moved. Therefore, the agitator stored in a storage may be brought out to a workplace and used only when needed.

For example, in case that the agitator is used to manufacture shampoo, only the single agitator is used in the related art. For this reason, when the type of shampoo to be manufactured is changed, the agitator needs to be essentially cleaned, which delays the manufacturing process and requires a large amount of water to clean the agitator. In contrast, the agitator according to the present disclosure may be configured to be movable and easily moved to a desired position. Therefore, the agitators may be set for respective types of shampoo, and the agitator, which is required for the manufacturing process, may be brought out of the storage and used, which may reduce the time and water required to clean the agitator.

In addition, the agitator according to the present disclosure agitates the agitation target by sucking the agitation target from the lower end of the agitation tank 110 by using the pump 130, and then circulating the sucked agitation target toward the upper portion of the agitation tank 110. Therefore, the agitation target in the agitation tank 110 may be entirely and uniformly agitated, and the agitation activators 200 installed in the suction pipe and the discharge pipe may promote the agitation: of the agitation target, thereby remarkably improving the agitation efficiency.

The present disclosure is not limited to the specific exemplary embodiment described above, various modifications can be made by any person skilled in the art to which the present disclosure pertains without departing from the subject matter of the present disclosure as claimed in the claims, and the modifications are within the scope defined by the claims.

What is claimed is:

1. An agitator that circulates materials comprising:
an agitation tank (110) into which an agitation target is inputted;
a base plate (120) configured to support the agitation tank (110) from below the agitation tank (110);
pumps (130) fixedly installed on the base plate (120), connected to a lower end of the agitation tank (110) through suction pipes, and configured to suck the agitation target in the agitation tank (110), the pumps (130) being connected to an upper end of the agitation tank (110) through discharge pipes and configured to circulate the sucked agitation target by discharging the agitation target to the upper end of the agitation tank (110); and
an agitation activator (200) installed in at least one of the suction pipe and the discharge pipe and configured to promote agitation of the agitation target.

2. The agitator that circulates materials of claim 1, wherein the pumps (130) comprise a first pump (131) and a second pump (132),
wherein the first pump (131) is connected to the agitation tank (110) through a first suction pipe (133) and a first discharge pipe (134), and the second pump (132) is connected to the agitation tank (110) through a second suction pipe (135) and a second discharge pipe (136), such that the first and second pumps (131 and 132) independently circulate the agitation target, and
wherein the first discharge pipe (134) and the second discharge pipe (136) are formed such that two flows formed by the agitation target discharged into the agitation tank (110) collide with each other while intersecting each other in the agitation tank (110).

3. The agitator that circulates materials of claim 1, further comprising:
a plurality of stoppers (122) provided uprightly in a vertical posture from an upper surface of the base plate (120) and installed on the base plate (120) to support the lower end of the agitation tank (110) in forward, rearward, leftward, and rightward directions; and
a plurality of casters (121) distributed and installed on a bottom surface of the base plate (120) to make it easy to move a position of the agitator that circulates materials.

4. The agitator that circulates materials of claim 1, wherein the agitation activator (200) comprises:
a tubular housing (210) having an inlet port formed at one side thereof, and a discharge port formed at a side opposite to the inlet port;
a copper pipe (220) made of copper and installed and structured to be in close contact with an inner peripheral surface of the tubular housing (210);
a first treatment member (230) disposed in the copper pipe (220) so as to come into earliest contact with the agitation target introduced into the tubular housing (210), the first treatment member (230) being made of copper, having a two-stage structure including a large-diameter portion (231) provided to be in close contact with the inner peripheral surface of the copper pipe (220), and a small-diameter portion (232) spaced apart from the inner peripheral surface of the copper pipe (220), and configured such that the agitation target is introduced through a central portion of the large-diameter portion (231) and then discharged into a space between the small-diameter portion (232) and the copper pipe (220) while being distributed in a circumferential direction of the small-diameter portion (232);
a second treatment member (240) made of zinc and having a two-stage structure including a large-diameter portion (241) provided to be in close contact with the inner peripheral surface of the copper pipe (220), and a small-diameter portion (242) spaced apart from the inner peripheral surface of the copper pipe (220), the second treatment member (240) being disposed in the copper pipe (220) so that the small-diameter portion (242) faces the small-diameter portion (232) of the first treatment member (230) and configured such that the agitation target is introduced inward through the small-diameter portion (242) and then discharged through a central portion of the large-diameter portion (241);
magnets (250) installed outside the copper pipe (220) to form a magnetic field between the first treatment member (230) and the second treatment member (240);
a third treatment member (260) made of polytetrafluoroethylene and having a two-stage structure including a large-diameter portion (261) provided to be in close contact with the inner peripheral surface of the copper pipe (220), and a small-diameter portion (262) spaced apart from the inner peripheral surface of the copper pipe (220), the third treatment member (260) being disposed in the copper pipe (220) so that the large-diameter portion (261) faces the large-diameter portion (241) of the second treatment member (240) and configured such that the agitation target introduced inward through a central portion of the large-diameter portion (261) and then discharged into a space between the small-diameter portion (262) and the copper pipe (220) while being distributed in a circumferential direction of the small-diameter portion (262); and
a fourth treatment member (270) made of copper and having a two-stage structure including a large-diameter portion (271) provided to be in close contact with the inner peripheral surface of the copper pipe (220), and a small-diameter portion (272) spaced apart from the inner peripheral surface of the copper pipe (220), the fourth treatment member (270) being disposed in the copper pipe (220) so that the small-diameter portion (272) faces the small-diameter portion (262) of the third treatment member (260) and configured such that the agitation target is introduced through the small-diameter portion (272) and then discharged through a central portion of the large-diameter portion (271).

5. The agitator that circulates materials of claim 4, further comprising:
a plurality of first space forming protrusions (234) protruding from an end surface of the small-diameter portion (232) of the first treatment member (230) toward the second treatment member (240) and spaced apart from one another in the circumferential direction of the small-diameter portion (232) to define inlets (281) through which the agitation target is introduced; and
a plurality of second space forming protrusions (245) protruding from an end surface of the small-diameter portion (242) of the second treatment member (240) toward the first treatment member (230) and spaced apart from one another in the circumferential direction of the small-diameter portion (242) to define inlets (281) through the agitation target is introduced, the second space forming protrusions (245) being in close contact with the first space forming protrusions (234) while facing the first space forming protrusions (234) so that the first treatment member (230) and the second treatment member (240) are spaced apart from each other to define an activation space (280).

6. The agitator that circulates materials of claim 5, wherein the magnets (250) are installed on the copper pipe (220), positioned in a section between the first treatment member (230) and the second treatment member (240), and configured to form a magnetic field in the activation space (280).

7. The agitator that circulates materials of claim 5, wherein the second treatment member (240) comprises:
a plurality of first inflow holes (243) formed and distributed in the end surface of the small-diameter portion (242) so that the agitation target in the activation space (280) is introduced into the large-diameter portion (241); and
a plurality of second inflow holes (244) distributed in the circumferential direction between the small-diameter portion (242) and the large-diameter portion (241), disposed in an obliquely inclined posture, and connected to an internal space of the large-diameter portion (241).

8. The agitator that circulates materials of claim 5, wherein two opposite surfaces of the first space forming protrusion (234) and two opposite surfaces of the second space forming protrusion (245), which define the inlet, are formed to be inclined so that the agitation target introduced into the activation space (280) through the inlet creates a flow swirling in the activation space (280).
